(19) United States
(12) Patent Application Publication
(10) Pub. No.: US 2022/0140520 A1
(43) Pub. Date: May 5, 2022

(54) WATERPROOF MULTI-OUTLET

(71) Applicant: Frog Electric Co., Ltd., Seoul (KR)

(72) Inventor: SUNG GUEN EUN, Seoul (KR)

(21) Appl. No.: 17/102,584

(22) Filed: Nov. 24, 2020

(30) Foreign Application Priority Data
Nov. 4, 2020 (KR) 20-2020-0003982

(51) Int. Cl. H01R 13/52

(52) U.S. Cl. CPC H01R 13/5202; H01R 25/00

(57) ABSTRACT

Disclosed herein is a waterproof multi-outlet. The waterproof multi-outlet includes: an outlet body configured such that an open top surface, a closed bottom surface, and side surfaces connecting the top and bottom surfaces are included and a space portion accommodating an electromagnetic circuit is formed therein; a flat plate-shaped cover plate coupled to the top surface of the outlet body to close the space portion; and a leakage blocking member disposed along an edge of the top surface of the outlet body, and configured to adhesively fix the outlet body and the cover plate because an adhesive is applied onto both sides of thereof. The outlet body has a structure in which at least one plug insertion hole for plug connection is formed in the side of the outlet body, and thus water is prevented from entering the inner space of the outlet body.

### CROSS-REFERENCE TO RELATED APPLICATION

This application claims the benefit of Korean Patent Application No. 20-2020-0003982 filed on Nov. 4, 2020, which is hereby incorporated by reference herein in its entirety.

### BACKGROUND

### 1. Technical Field

The present invention relates generally to a waterproof multi-outlet, and more particularly to a waterproof multi-outlet that may be used even in a submerged (underwater) state due to the excellent waterproofness thereof.

### 2. Description of the Related Art

Korean Patent No. 10-0611574 discloses an outlet having a waterproof structure. This will now be described in detail. As shown in FIG. 1, the outlet is enclosed with a casing 10′ that provides a sealed space, a socket 12′ having threads formed along the outer circumference thereof protrudes from the casing in an integrated manner on the outer circumference of a connection portion 11′ exposed forward for plug connection, an outlet 1′ provided with a sealing member S1′ and two terminal rods 22′ fitted into a connection hole disposed in an inner connection part inside a socket 12′ are included on the socket 12′ and the outer circumference of the end of the socket 12′ connected to the casing 10′, a plug 2′ provided with a ring-shaped sealing member S2′ having an extended cross section is provided on a cable C′ on a connection portion with the cable C′ at one end of the case 20′, and a waterproof cap 3′ having threads for screw fastening with the socket 12′ is provided on the inner diameter of one end opened as a cone-shaped hollow tube that can cover the plug 2′.

However, according to the above conventional outlet, the structure of the casing is not suitable for use underwater because the casing is chiefly buried in a wall. Furthermore, in the casing coupling structure that is used to form the casing, the sealing for the portions where coupling is performed by bolts or screws is incomplete. Accordingly, a problem arises in that water enters the casing in a submerged (underwater) state due to hydraulic pressure.

### SUMMARY

The present invention has been conceived to overcome the above-described problems, and an object of the present invention is to provide a waterproof multi-outlet that may reduce manufacturing cost and be easily manufactured because it has a simple structure and that may maintain performance in a submerged (underwater) state because the waterproofness thereof is excellent even in the submerged (underwater) state.

In order to accomplish the above object, the present invention provides a waterproof multi-outlet including: an outlet body configured such that an open top surface, a closed bottom surface, and side surfaces connecting the top and bottom surfaces are included and a space portion accommodating an electromagnetic circuit is formed therein; a flat plate-shaped cover plate coupled to the top surface of the outlet body to close the space portion; and a leakage blocking member disposed along an edge of the top surface of the outlet body, and configured to adhesively fix the outlet body and the cover plate because an adhesive is applied onto both sides of thereof; wherein the outlet body has a structure in which at least one plug insertion hole for plug connection is formed in the side of the outlet body, and thus water is prevented from entering the inner space of the outlet body.

The leakage blocking member may a size and shape corresponding to those of a top edge of the outlet body, may be made of a material containing a resin having excellent waterproof performance and storage elasticity, and may include: a base layer; a first adhesive layer formed on one surface of the base layer, made of an adhesive, and configured to come into close contact with the outlet body; and a second adhesive layer formed on a back surface of the base layer, made of an adhesive, and configured to come into close contact with the cover plate.

The waterproof multi-outlet may further include a first fixing means configured to fix the cover plate and the outlet body to each other, and the first fixing means may include: a plurality of through holes formed along an edge of the cover plate; a plurality of coupling holes formed along an edge a top surface of the outlet body; and a plurality of insertion members each inserted to sequentially pass through the through hole, the leakage blocking member, and the coupling hole.

The waterproof multi-outlet may further include a plurality of second fixing means configured to fix the cover plate and the outlet body to each other, and the second fixing means may include: a first fitting groove formed to be concave along a bottom surface of the cover plate; a plurality of second fitting grooves formed to be concave along an edge of a top surface of the outlet body; a first protrusion integrated with the leakage blocking member and protruding from the second adhesive layer in a shape corresponding to that of the first fitting groove; and second protrusions protruding from the first adhesive layer in a shape corresponding to that of the second fitting grooves.

The plug insertion hole may include three plug insertion holes that are formed in each of two opposite side surfaces of the outlet body to be spaced apart from each other.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing the structure of a conventional waterproof outlet;

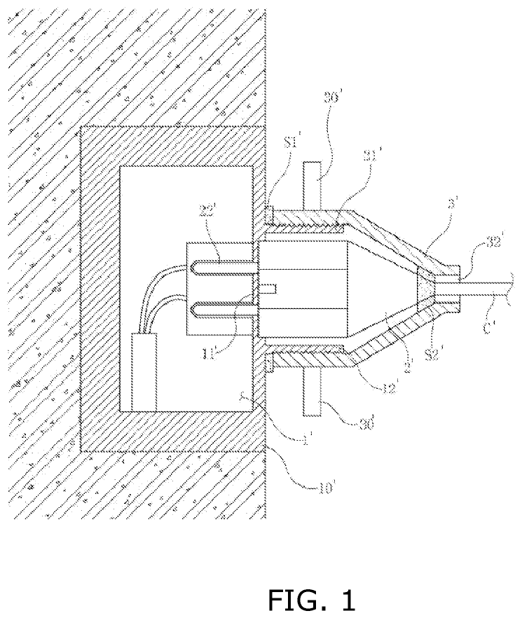

FIG. 2 is an exploded perspective view showing a state in which a waterproof multi-outlet according to the present invention is coupled together;

FIG. 3 shows a plan view and a sectional view of a waterproof multi-outlet according to an embodiment of the present invention;

FIG. 4 is a side view showing the shape of a leakage blocking member according to the present invention in detail; and

FIG. 5 shows a plan view and a sectional view of a waterproof multi-outlet according to another embodiment of the present invention.

### DETAILED DESCRIPTION

Embodiments of the present invention will be described with reference to the accompanying drawings below. In this process, the thicknesses of lines or the sizes of components shown in the drawings may be exaggerated for clarity and convenience of description.

Furthermore, terms to be described later are terms defined by taking into consideration the functions thereof in the present invention, which may vary according to the intention or custom of a user or operator. Accordingly, the definitions of these terms should be made based on the contexts thereof throughout the present specification.

Additionally, the following embodiments do not limit the scope of the present invention, but are merely illustrative of the components presented in the claims of the present invention. These embodiments are included in the technical spirit of the present invention throughout the specification of the present invention. Embodiments including components that can be substituted for the components of the claims as equivalents may be included in the scope of the present invention.

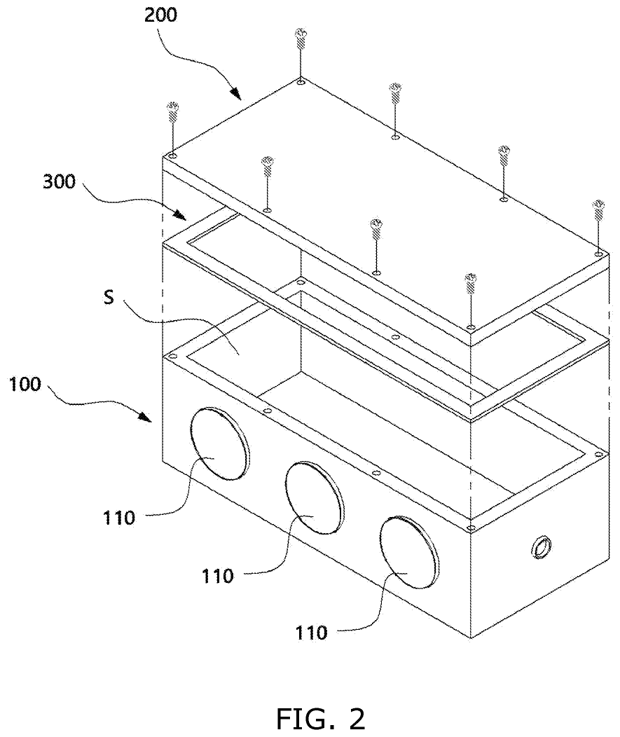

FIG. 2 is an exploded perspective view showing a state in which a waterproof multi-outlet according to the present invention is coupled together.

Referring to FIG. 2, the waterproof multi-outlet includes: an outlet body 100 configured such that an open top surface, a closed bottom surface, and side surfaces connecting the top and bottom surfaces are included and a space portion S accommodating an electromagnetic circuit is formed therein; a flat plate-shaped cover plate 200 coupled to the top surface of the outlet body to close the space portion S; and a leakage blocking member 300 disposed along the edge of the top surface of the outlet body 100, and configured to adhesively fix the outlet body 100 and the cover plate 200 because an adhesive is applied onto both sides of thereof. The outlet body 100 has a structure in which at least one plug insertion hole 110 for plug connection is formed in the side of the outlet body 100, and thus water is prevented from entering the inner space of the outlet body 100. Furthermore, as shown in the drawing, it is preferable that the outlet body 100 have a rectangular box shape. The plug insertion hole may have various structures in which airtightness is maintained when the outlet is fastened/unfastened and thus waterproof performance is imparted thereto.

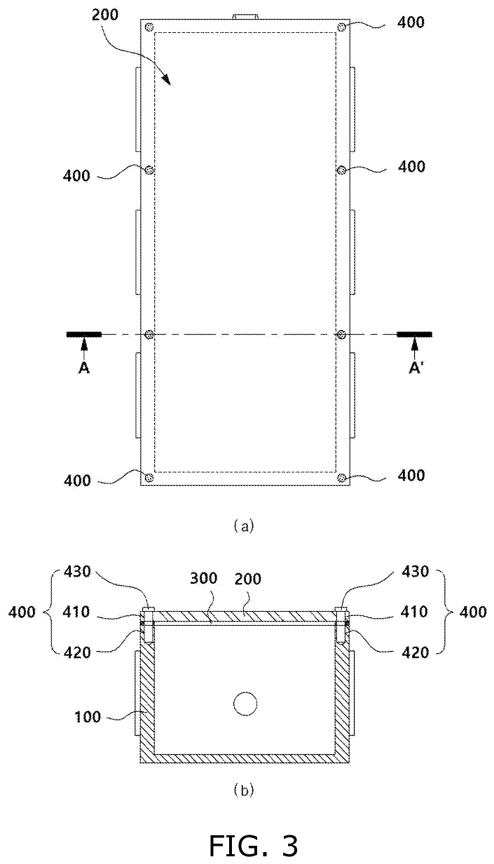

FIG. 3 shows a plan view and a sectional view of a waterproof multi-outlet according to an embodiment of the present invention. FIG. 3(a) is a plan view of the waterproof multi-outlet according to the embodiment of the present invention, and FIG. 3(b) is a sectional view of the multi-waterproof outlet shown in FIG. 3(a). According to the embodiment, as shown in FIG. 3, the waterproof multi-outlet further includes first fixing means 400 configured to fix the cover plate 200 and the outlet body 100 to each other. The first fixing means 400 includes: a plurality of through holes 410 formed along the edge of the cover plate 200; a plurality of coupling holes 420 formed along the edge of the top surface of the outlet body 100; and a plurality of insertion members 430 each inserted to sequentially pass through the through hole 410, the leakage blocking member 300, and the coupling hole 420.

The leakage blocking member 300 comes into close contact with the insertion member 430 passing through the leakage blocking member 300, and, at the same time, comes in completely close contact with the cover plate 200 and the outlet body 100. Accordingly, water is prevented from entering through the gap between each of the through holes 410 and the insertion member 430 fitted into the through hole 410. As a result, the waterproof multi-outlet is completely waterproof even in a submerged (underwater) state.

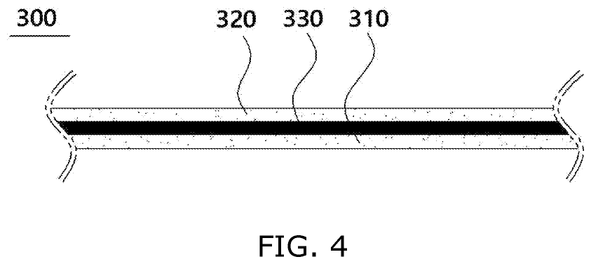

FIG. 4 is a side view showing the shape of the leakage blocking member of the present invention in detail.

Referring to FIG. 4, the leakage blocking member 300 has a size and shape corresponding to those of the top edge of the outlet body 100. The leakage blocking member 300 is made of a material containing a resin having excellent waterproof performance and storage elasticity. The leakage blocking member 300 includes: a base layer 330; a first adhesive layer 310 formed on one surface of the base layer 330, made of an adhesive, and configured to come into close contact with the outlet body 100; and a second adhesive layer 320 formed on the back surface of the base layer 330, made of an adhesive, and configured to come into close contact with the cover plate 100.

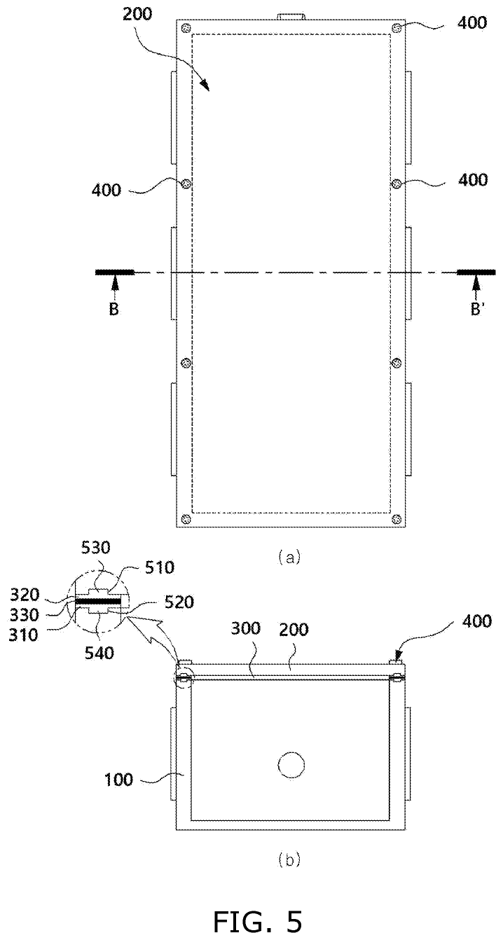

FIG. 5 shows a plan view and a sectional view of a waterproof multi-outlet according to another embodiment of the present invention. FIG. 5(a) is a plan view of the waterproof multi-outlet according to the other embodiment of the present invention, and FIG. 5(b) is a sectional view of the multi-waterproof outlet shown in FIG. 5(a).

Referring to FIG. 5, the waterproof multi-outlet according to the present embodiment of the present invention further includes a plurality of second fixing means 500 configured to fix the cover plate 200 and the outlet body 100 to each other.

The second fixing means 500 include: a first fitting groove 510 formed to be concave along the bottom surface of the cover plate 200; a plurality of second fitting grooves 520 formed to be concave along the edge of the top surface of the outlet body 100; a first protrusion 530 integrated with the leakage blocking member 300 and protruding from the second adhesive layer 320 in a shape corresponding to that of the first fitting groove 510; and second protrusions 540 protruding from the first adhesive layer 310 in a shape corresponding to that of the second fitting grooves 520.

According to the above-described structure, the cover plate and the outlet body may be effectively prevented from being separated from an adhered and fixed state by the force applied from the side.

According to the present invention, effects arise in that complete waterproofness is maintained when the waterproof multi-outlet is not in use as well as when the waterproof multi-outlet is in use because a plug is connected thereto and a waterproof function is maintained even when it is submerged, so that it is easy to manage the waterproof multi-outlet and the waterproof multi-outlet prevents short circuit and electric shock accidents, thereby dramatically improving safety.

Although the present invention has been described in detail through specific examples, this is intended to describe the present invention in detail, and the present invention is not limited thereto. It is apparent that modifications or improvements may be made by those of ordinary skill in the art within the technical spirit of the present invention.

All simple modifications or alterations of the present invention fall within the scope of the present invention, and the specific scope of protection of the present invention will be clearly defined by the appended claims.

What is claimed is:

1. A waterproof multi-outlet comprising:
an outlet body configured such that an open top surface, a closed bottom surface, and side surfaces connecting the top and bottom surfaces are included and a space portion accommodating an electromagnetic circuit is formed therein;
a flat plate-shaped cover plate coupled to the top surface of the outlet body to close the space portion; and
a leakage blocking member disposed along an edge of the top surface of the outlet body, and configured to adhesively fix the outlet body and the cover plate because an adhesive is applied onto both sides of thereof;
wherein the outlet body has a structure in which at least one plug insertion hole for plug connection is formed in the side of the outlet body, and thus water is prevented from entering the inner space of the outlet body.

2. The waterproof multi-outlet of claim 1, wherein:
the leakage blocking member has a size and shape corresponding to those of a top edge of the outlet body, and is made of a material containing a resin having excellent waterproof performance and storage elasticity; and
the leakage blocking member comprises:
a base layer;
a first adhesive layer formed on one surface of the base layer, made of an adhesive, and configured to come into close contact with the outlet body; and
a second adhesive layer formed on a back surface of the base layer, made of an adhesive, and configured to come into close contact with the cover plate.

3. The waterproof multi-outlet of claim 2, further comprising a first fixing means configured to fix the cover plate and the outlet body to each other;
wherein the first fixing means comprises:
a plurality of through holes formed along an edge of the cover plate;
a plurality of coupling holes formed along an edge a top surface of the outlet body; and
a plurality of insertion members each inserted to sequentially pass through the through hole, the leakage blocking member, and the coupling hole.

4. The waterproof multi-outlet of claim 3, further comprising a plurality of second fixing means configured to fix the cover plate and the outlet body to each other;
wherein the second fixing means comprise:
a first fitting groove formed to be concave along a bottom surface of the cover plate;
a plurality of second fitting grooves formed to be concave along an edge of a top surface of the outlet body;
a first protrusion integrated with the leakage blocking member and protruding from the second adhesive layer in a shape corresponding to that of the first fitting groove; and
second protrusions protruding from the first adhesive layer in a shape corresponding to that of the second fitting grooves.

5. The waterproof multi-outlet of claim 3, wherein the plug insertion hole comprises three plug insertion holes that are formed in each of two opposite side surfaces of the outlet body to be spaced apart from each other.

6. The waterproof multi-outlet of claim 4, wherein the plug insertion hole comprises three plug insertion holes that are formed in each of two opposite side surfaces of the outlet body to be spaced apart from each other.
